(19) United States
(12) Patent Application Publication
(10) Pub. No.: US 2015/0235596 A1
(43) Pub. Date: Aug. 20, 2015

(54) METHOD AND DEVICE FOR CONTROLLING APPLICATIONS

(71) Applicant: TENCENT TECHNOLOGY (SHENZHEN) COMPANY LIMITED, Shenzhen (CN)

(72) Inventors: Jinggang LU, Shenzhen (CN); Li KONG, Shenzhen (CN); Dongsheng NIU, Shenzhen (CN); Yu ZHANG, Shenzhen (CN); Ruilin MA, Shenzhen (CN)

(21) Appl. No.: 14/702,239

(22) Filed: May 1, 2015

Related U.S. Application Data
(63) Continuation of application No. PCT/CN2013/084871, filed on Oct. 9, 2013.

(30) Foreign Application Priority Data
Nov. 5, 2012 (CN) 201210435802.6

(51) Int. Cl. G09G 3/34

(52) U.S. Cl. CPC G09G 3/34; G09G 2360/144; G09G 2320/0626

(57) ABSTRACT

According to an example of the present disclosure, a light intensity value of an environment, at which a terminal device may be located, may be obtained. Whether the light intensity value of the environment may be less than or equal to a preset value may be determined. Whether a browser of the terminal device may be in a Night Mode may be determined if the light intensity value of the environment may be less than or equal to the preset value. The Night Mode of the browser of the terminal device may be turned on if the browser may not be in the Night Mode.

### CROSS-REFERENCE TO RELATED APPLICATIONS

This application is a continuation of International Application No. PCT/CN2013/084871, filed on Oct. 9, 2013, which claims priority to Chinese patent application No. 201210435802.6, filed on Nov. 5, 2012, the contents of both of which are incorporated herein by reference in their entireties.

### FIELD OF THE INVENTION

The present disclosure relates to a communication technology field, and more particularly, to a method and device for controlling an application.

### BACKGROUND

Along with development of a browser and an intelligent terminal device, how to improve users' experiences for using the browser may be a problem to be solved by operators.

In the conventional method, the browser may provide a Night Mode for users, so that the users may be comfortable to use the browser. The user may manually set time for turning on/turning off the Night Mode in the browser. For instance, the user may set turning on the Night Mode at 23:00 and turning off the Night Mode at 5:00. Therefore, the browser may automatically turn on the Night Mode at 23:00 and turn off the Night Mode at 5:00.

In the conventional method, the time for turning on/turning off the Night Mode of the browser may need to be manually set. Since the location of the user may be uncertain, it may not be suitable to turn on the Night Mode in the environment of the terminal device at 23:00, so that the turning-on of the Night Mode may not be intelligently controlled according to the environment and the experiences of the user for using the browser may be low.

### SUMMARY

In order to intelligently control the turning-on of the Night Mode of the browser according to the current environment, examples of the present disclosure may provide a method and device for controlling an application. The technical scheme may be as follows.

A method for controlling an application includes:

obtaining a light intensity value of an environment, at which a terminal device is located;

determining whether the light intensity value of the environment is less than or equals to a preset value;

determining whether a browser of the terminal device is in a Night Mode if the light intensity value of the environment is less than or equals to the preset value; and

turning on the Night Mode of the browser of the terminal device if the browser is not in the Night Mode.

The method for obtaining the light intensity value of the environment includes:

monitoring a light sensor on the terminal device; and

receiving the light intensity value of the environment from the light sensor.

Before the light sensor on the terminal device is monitored, the method further includes:

receiving an instruction for turning on the Night Mode;

sending a request for registering monitoring to the light sensor to monitor the light sensor.

After the Night Mode of the browser of the terminal device is turned on, the method further includes:

outputting display contents according to display parameters of the Night Mode. The display parameters include: a display background, display brightness and/or display colors.

The method further includes:

determining whether the browser of the terminal device is in the Night Mode if the light intensity value of the environment is larger than the preset value; and

turning off the Night Mode of the browser if the browser of the terminal device is in the Night Mode.

According to another example, a device for controlling an application includes:

an obtaining module, to obtain a light intensity value of an environment, at which a terminal device is located;

a determination module, to determine whether the light intensity value of the environment is less than or equals to a preset value; and

a turning-on module, to determine whether a browser of the terminal device is in a Night Mode if the determination module determines that the light intensity value of the environment is less than or equals to the preset value and turn on the Night Mode of the browser of the terminal device if the browser is not in the Night Mode.

The obtaining module includes:

a monitoring unit, to monitor a light sensor on the terminal device and receive the light intensity value of the environment from the light sensor.

The obtaining module further includes:

a registering unit, to receive an instruction for turning on the Night Mode before the monitoring unit monitors the light sensor on the terminal device and send a request for registering monitoring to the light sensor to monitor the light sensor.

The device further includes:

a displaying module, to output display contents according to display parameters of the Night Mode after the turning-on module turns on the Night Mode of the browser of the terminal device. The display parameters comprise: a display background, display brightness and/or display colors.

The device further includes:

a turning-off module, to determine whether the browser of the terminal device is in the Night Mode if the determination module determines that light intensity value of the environment is larger than the preset value and

turn off the Night Mode of the browser if the browser of the terminal device is in the Night Mode.

According to an example, a non-transitory computer-readable medium storing instructions which, when being executed by one or more processors, cause a device to perform a method for controlling an application may be provided. The method may include:

obtaining a light intensity value of an environment, at which a terminal device is located;

determining whether the light intensity value of the environment is less than or equals to a preset value;

determining whether a browser of the terminal device is in a Night Mode if the light intensity value of the environment is less than or equals to the preset value; and

turning on the Night Mode of the browser of the terminal device if the browser is not in the Night Mode.

The technical effects of the examples of the present disclosure may be: obtaining the light intensity of the current environment, at which the terminal device may be located, determining whether the light intensity value of the current environment may be less than or equal to the preset value, determining whether the browser of the terminal device may be in the Night Mode if the light intensity value of the current environment may be less than or equal to the preset value and turning on the Night Mode of the browser of the terminal device if the browser may not be in the Night Mode. Therefore, the function for intelligently controlling the turning-on of the Night Mode of the browser may be implemented.

### BRIEF DESCRIPTION OF THE DRAWINGS

In order to clearly describe the technical scheme in the present disclosure, a brief description may be given to accompanying figures used in following examples. Obviously, the accompanying figures described hereinafter may be some examples in the present disclosure. An ordinary skilled in the art may obtain other figures with these accompanying figures without creative work.

FIG. 1 is a flow chart illustrating a method for controlling an application in accordance with an example of the present disclosure;

FIG. 2 is a flow chart illustrating another method for controlling an application in accordance with an example of the present disclosure;

FIG. 3 is a schematic diagram illustrating structure of a device for controlling an application in accordance with an example of the present disclosure;

FIG. 4 is a schematic diagram illustrating another structure of a device for controlling an application in accordance with an example of the present disclosure; and

FIG. 5 is a schematic diagram illustrating another structure of a device for controlling an application in accordance with an example of the present disclosure.

### DETAILED DESCRIPTION

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

### Embodiment One

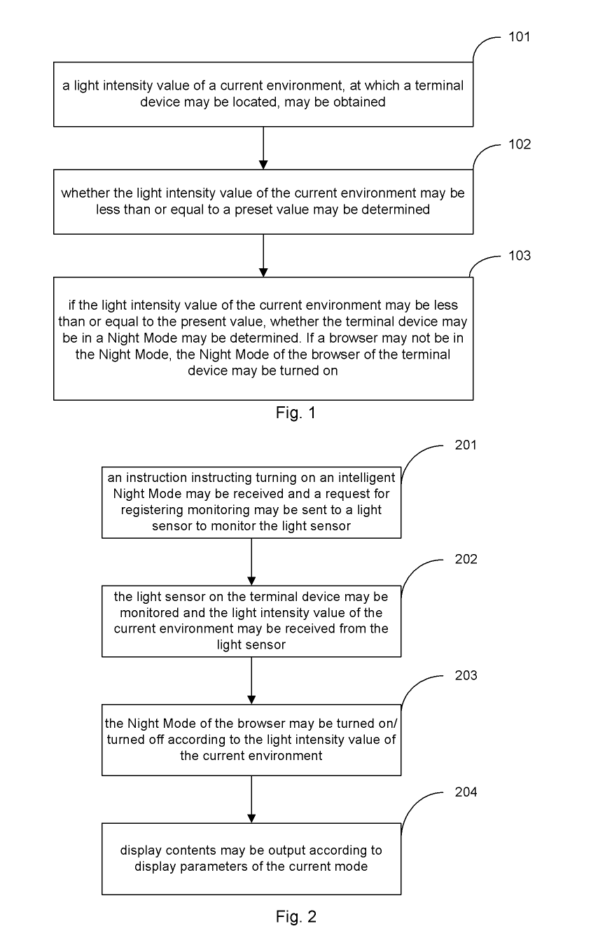

Referring to FIG. 1, FIG. 1 is a flow chart illustrating a method for controlling an application in accordance with an embodiment of the present example. The method may include the following blocks.

In block 101, a light intensity value of a current environment, at which a terminal device may be located, may be obtained.

In block 102, whether the light intensity value of the current environment may be less than or equal to a preset value may be determined.

In block 103, if the light intensity value of the current environment may be less than or equal to the present value, whether the terminal device may be in a Night Mode may be determined. If a browser may not be in the Night Mode, the Night Mode of the browser of the terminal device may be turned on.

The method for obtaining the light intensity of the current environment may include monitoring a light sensor on the terminal device and receiving the light intensity value of the current environment from the light sensor.

Before the light sensor on the terminal device is monitored, the method may further include: receiving an instruction for turning on the Night Mode and sending a request for registering monitoring to the light sensor to monitor the light sensor.

After the Night Mode of the browser of the terminal device is turned on, the method may further include: outputting display contents, i.e. to-be-displayed contents, according to display parameters of the Night Mode. The display parameters may include a display background, display brightness and/or display colors.

In addition, the method may further include determining whether the browser of the terminal device may be in the Night Mode if the light intensity value of the current environment is larger than the preset value. If the light intensity value of the current environment is larger than the preset value, the Night Mode of the browser may be turned off.

The technical effects of the examples of the present disclosure may be: obtaining the light intensity of the current environment, at which the terminal device may be located, determining whether the light intensity value of the current environment may be less than or equal to the preset value, determining whether the browser of the terminal device may be in the Night Mode if the light intensity value of the current environment may be less than or equal to the preset value and turning on the Night Mode of the browser of the terminal device if the browser may not be in the Night Mode. Therefore, the function for intelligently controlling the turning-on of the Night Mode of the browser may be implemented.

### Embodiment Two

An example of the present disclosure may provide a method for controlling an application to enhance users' experiences in using the browser and intelligently set the Night Mode in the browser. The Night Mode may be a mode set by the browser for a weak light environment. When the user sets the Night Mode for the browser, in the weak light environment, the browser may automatically adjust the background, brightness and colors of the display contents. The parameters may be adjusted to achieve a soft display effect to reduce stimulation of users' eyes caused by contract between the display brightness of the browser and the brightness of the environment.

Referring to FIG. 2, the method may include the following blocks.

In block 201, an instruction instructing turning on an intelligent Night Mode may be received and a request for registering monitoring may be sent to a light sensor to monitor the light sensor.

The intelligent Night Mode is an entrance to control the browser to automatically turn on/turn off the Night Mode. After the intelligent Night Mode is turned on, the browser may automatically turn on/turn off the Night Mode according to the light intensity value of the current environment. In practice, in this example of the present disclosure, an option for turning on/turning off the intelligent Night Mode may be set in the browser. When a user clicks on the option, the function for turning on/turning off the intelligent Night Mode may be implemented. The option may be set on the interface of the browser or set in a system menu of the browser, which is not limited in this example of the present disclosure.

In this example of the present disclosure, a monitoring module may be set in the browser. When the browser turns on the intelligent Night Mode, the browser may send a request for registering monitoring to the light sensor so that the monitoring module may monitor the light sensor. Therefore, the light sensor may report the brightness of the environment, at which the terminal device may be located, to the browser. Therefore, the browser may monitor the brightness of the environment, at which the terminal device may be located, via the light sensor of the terminal device in time. In this example, the brightness of the environment may be monitored periodically, such as monitored every 5, 8, 10 or 60 seconds, which are not limited in this example of the present disclosure.

It should be noted that the block 201 may need to be executed when the browser does not turn on the intelligent Night mode. In practice, if the browser has already turned on the intelligent Night Mode, the block 201 may not need to be implemented. Therefore, the block 201 is optional.

In block 202, the light sensor on the terminal device may be monitored and the light intensity value of the current environment may be received from the light sensor.

In this example, the light sensor may monitor the light intensity of the current environment, at which the terminal device may be located, in time, compute the light intensity value and report a computing result to the browser. When the browser is in use, a relatively short time interval, such as 3 or 5 seconds, may be set for the light sensor to report the computing result. If the browser is not in use, a relatively long time interval, such as 1 minute or 2 minutes, may be set for the light sensor to report the computing result. Therefore, the system resources of the terminal device may be saved and the system performances may be enhanced.

The light intensity value of the current environment, at which the terminal device may be located, may be obtained in block 202. In practice, the browser may obtain the light intensity value of the current environment via other methods, which are not listed in this example of the present disclosure.

In block 203, the Night Mode of the browser may be turned on/turned off according to the light intensity value of the current environment.

In this example, after the user sets the intelligent Night Mode of the browser, the browser may automatically turn on/turn off the Night Mode of the browser according to the light intensity value of the current environment. After the browser obtains the light intensity value of the current environment, at which the terminal device is located, it may be determined whether the light intensity value may be less than or equal to the preset value. If the light intensity value of the current environment may be less than or equal to the preset value, it may be determined whether the browser may be in the Night Mode. If the browser may not be in the Night Mode, the interface for turning on the Night Mode may be called to use the browser in the Night Mode. If the current browser may be in the Night Mode, the operation for monitoring the light intensity value of the current environment in block 202 may be performed.

The preset value may be set according to one of hardware parameters and software parameters of the terminal device and the change of the light intensity value of the environment, at which the terminal device may be located. This example of the present disclosure does not make limitation on the preset value.

In addition, in this example of the present disclosure, if the light intensity value of the current environment may be larger than the preset value, it may be determined whether the current browser may be in the Night Mode. If the current browser may be in the Night Mode, the interface for turning off the Night Mode may be called to use the browser in a non-Night Mode. If the current browser may not be in the Night Mode, the block 202 may be performed to continue to monitor the light intensity value of the current environment. The non-Night Mode is a browser display mode contrary to the Night Mode. It is suitable to use the Non-Night Mode in the day time or in an environment with sufficient lightness.

In this example of the present disclosure, the browser core may provide an interface for turning on/turning off the Night Mode to a browser UI module. The Night Mode may be turned on or turned off by calling the interface for turning on/turning off the Night Mode.

In block 204, display contents may be output according to display parameters of the current mode.

In this example of the present disclosure, the current mode may refer to the Night Mode or the Non-Night Mode. After the Night Mode is turned on, the display parameters of the browser may be modified by the interface for turning on the Night Mode provided by the browser core to the browser UI mode to implement the effect of the Night mode. After the Night Mode may be turned off, the display parameters of the browser may be modified by the interface for turning off the Night mode provided by the browser core to the browser UI module to implement the Non-Night Mode. The display parameters may include but may not be limited to the display background, the display brightness and/or display colors, etc.

Since the hardware parameters and software parameters of each terminal device may be different, the method for setting the display parameters of the Night Mode and the Non-Night Mode may be different. The examples of the present disclosure do not make limitation on the method for setting the display parameters.

The technical effects of the examples of the present disclosure may be: obtaining the light intensity of the current environment, at which the terminal device may be located, determining whether the light intensity value of the current environment may be less than or equal to the preset value, determining whether the browser of the terminal device may in the Night Mode if the light intensity value of the current environment may be less than or equals to the preset value and turning on the Night Mode of the browser of the terminal device if the browser may not be in the Night Mode. Therefore, the function for intelligently controlling the turning-on of the Night Mode of the browser may be implemented. In addition, the function for automatically turning off the Night Mode may be implemented via monitoring the light intensity value.

### Embodiment Three

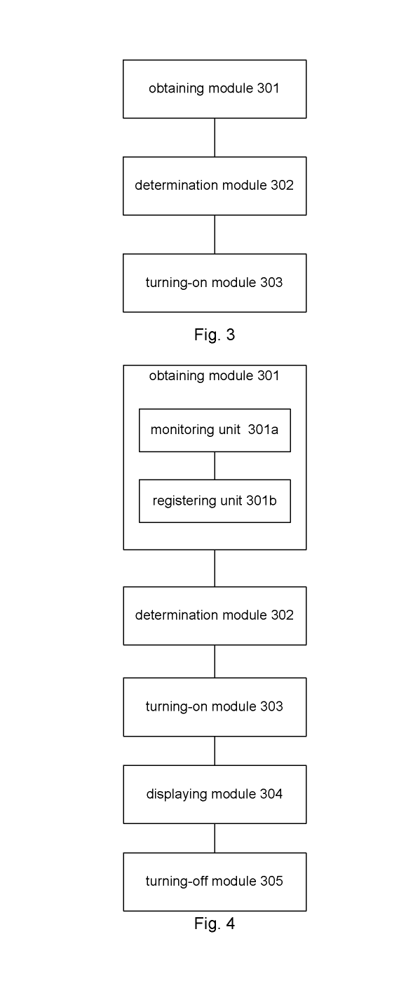

Referring to FIG. 3, FIG. 3 is a schematic diagram illustrating structure of a device for controlling an application in according with an example of the present disclosure. The device may include an obtaining module 301, a determination module 302 and a turning-on module 303.

The obtaining module 301 is to obtain a light intensity value of an environment, at which a terminal device is located.

The determination module 302 is to determine whether the light intensity value of the environment is less than or equals to a preset value.

The turning-on module is to determine whether a browser of the terminal device is in a Night Mode if the determination module 302 determines that the light intensity value of the environment is less than or equals to the preset value and turn on the Night Mode of the browser of the terminal device if the browser is not in the Night Mode.

Referring to FIG. 4, the obtaining module 301 may further include a monitoring unit 301a, to monitor a light sensor on the terminal device and receive the light intensity value of the environment from the light sensor.

Referring to FIG. 4, the obtaining module 301 may further include a registering unit 301b, to receive an instruction for turning on the Night Mode before the monitoring unit 301a monitors the light sensor on the terminal device and send a request for registering monitoring to the light sensor to monitor the light sensor with the monitoring unit 301a.

Referring to FIG. 4, the device may further include a displaying module 304, to output display contents according to display parameters of the Night Mode after the turning-on module 303 turns on the Night Mode of the browser of the terminal device.

The display parameters may include: a display background, display brightness and/or display colors.

Furthermore, referring to FIG. 4, the device may further include: a turning-off module 305, to determine whether the browser of the terminal device is in the Night Mode if the determination module 302 determines that light intensity value of the environment is larger than the preset value and turn off the Night Mode of the browser if the browser of the terminal device is in the Night Mode.

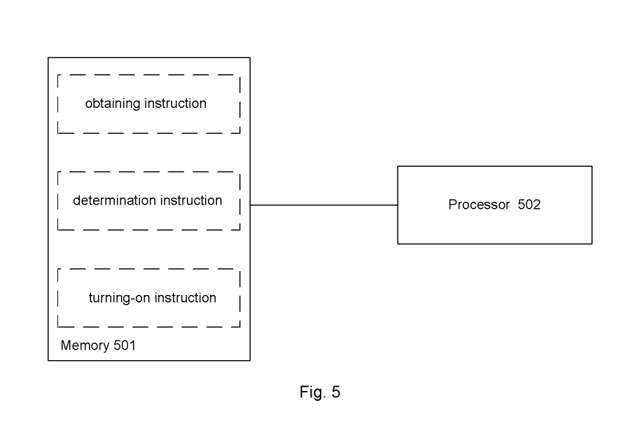

Referring FIG. 5, FIG. 5 is schematic diagram illustrating another structure of a device for controlling an application in accordance with an example of the present disclosure.

The device may include a memory 501 and a processor 502.

The memory 501 may include an obtaining instruction, a determination instruction and a turning-on instruction.

The processor 502 may communicate with the memory, to execute

the obtaining instruction, to obtain a light intensity value of an environment, at which a terminal device is located;

the determination instruction to determine whether the light intensity value of the environment is less than or equals to a preset value; and

the turning-on instruction, to determine whether a browser of the terminal device is in a Night Mode if determining that the light intensity value of the environment is less than or equals to the preset value and turn on the Night Mode of the browser of the terminal device if the browser is not in the Night Mode.

According to an example, the obtaining instruction may include a monitoring sub-instruction. The processor 502 may further execute the monitoring sub-instruction to monitor a light sensor on the terminal device and receive the light intensity value of the environment from the light sensor.

According to an example, the obtaining instruction may further include a registering sub-instruction. The processor 502 may further execute the registering sub-instruction to receive an instruction for turning on the Night Mode before the light sensor on the terminal device is monitored and send a request for registering monitoring to the light sensor to monitor the light sensor.

According to an example, the memory 501 may further include a displaying instruction. The processor 502 may further execute the displaying instruction to output display contents according to display parameters of the Night Mode after the Night Mode of the browser of the terminal device is turned on.

The display parameters may include: a display background, display brightness and/or display colors.

According to an example, the memory 501 may further include a turn-off instruction. The processor 502 may further execute the turn-off instruction to determine whether the browser of the terminal device is in the Night Mode if determining that light intensity value of the environment is larger than the preset value and turn off the Night Mode of the browser if the browser of the terminal device is in the Night Mode.

According to an example, an example of the present disclosure may provide a non-transitory computer-readable medium storing instructions which, when being executed by one or more processors, cause a device to perform a method for controlling an application, including:

obtaining a light intensity value of an environment, at which a terminal device is located;

determining whether the light intensity value of the environment is less than or equals to a preset value;

determining whether a browser of the terminal device is in a Night Mode if the light intensity value of the environment is less than or equals to the preset value; and

turning on the Night Mode of the browser of the terminal device if the browser is not in the Night Mode.

The technical effects of the examples of the present disclosure may be: obtaining the light intensity of the current environment, at which the terminal device may be located, determining whether the light intensity value of the current environment may be less than or equal to the preset value, determining whether the browser of the terminal device may in the Night Mode if the light intensity value of the current environment may be less than or equal to the preset value and turning on the Night Mode of the browser of the terminal device if the browser may not be in the Night Mode. Therefore, the function for intelligently controlling the turning-on of the Night Mode of the browser may be implemented.

It may be noted that the device for controlling the application in the above examples of the present disclosure may be described above taking the above function modules for example. In practice, the above functions may be implemented via different function modules. That is, the device may be divided into different function modules to implement all or partial functions mentioned above.

In addition, the device for controlling the application provided by the above examples and the method for controlling the application described above may belong to a same conception. The processing for implementing the device and the method has been described in the above examples, which are not repeated here.

The numbers in the above examples may be used for description, but may not represent merits of the above examples.

With the above description of the above examples, one ordinary skilled in the art of the present disclosure may know that examples of the present disclosure may be implemented with hardware or may be implemented with hardware instructed by programs. The programs may be stored in a computer readable storage medium, such as a ROM, a disk, or a CD.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for controlling an application, comprising:
obtaining a light intensity value of an environment, at which a terminal device is located;
determining whether the light intensity value of the environment is less than or equals to a preset value;
determining whether a browser of the terminal device is in a Night Mode if the light intensity value of the environment is less than or equals to the preset value; and
turning on the Night Mode of the browser of the terminal device if the browser is not in the Night Mode.

2. The method according to claim 1, wherein obtaining the light intensity value of the environment comprises:
monitoring a light sensor on the terminal device; and
receiving the light intensity value of the environment from the light sensor.

3. The method according to claim 2, wherein before the light sensor on the terminal device is monitored, the method further comprises:
receiving an instruction for turning on the Night Mode;
sending a request for registering monitoring to the light sensor to monitor the light sensor.

4. The method according to claim 1, wherein after the Night Mode of the browser of the terminal device is turned on, the method further comprises:
outputting display contents according to display parameters of the Night Mode; wherein
the display parameters comprise: a display background, display brightness and/or display colors.

5. The method according to claim 1, wherein the method further comprises:
determining whether the browser of the terminal device is in the Night Mode if the light intensity value of the environment is larger than the preset value; and
turning off the Night Mode of the browser if the browser of the terminal device is in the Night Mode.

6. A device for controlling an application, comprising:
an obtaining module, to obtain a light intensity value of an environment, at which a terminal device is located;
a determination module, to determine whether the light intensity value of the environment is less than or equals to a preset value; and
a turning-on module, to determine whether a browser of the terminal device is in a Night Mode if the determination module determines that the light intensity value of the environment is less than or equals to the preset value and turn on the Night Mode of the browser of the terminal device if the browser is not in the Night Mode.

7. The device according to claim 6, wherein the obtaining module comprises:
a monitoring unit, to monitor a light sensor on the terminal device and receive the light intensity value of the environment from the light sensor.

8. The device according to claim 7, wherein the obtaining module further comprises:
a registering unit, to receive an instruction for turning on the Night Mode before the monitoring unit monitors the light sensor on the terminal device and send a request for registering monitoring to the light sensor to monitor the light sensor.

9. The device according to claim 6, wherein the device further comprises:
a displaying module, to output display contents according to display parameters of the Night Mode after the turning-on module turns on the Night Mode of the browser of the terminal device; wherein
the display parameters comprise: a display background, display brightness and/or display colors.

10. The device according to claim 6, wherein the device further comprises:
a turning-off module, to determine whether the browser of the terminal device is in the Night Mode if the determination module determines that light intensity value of the environment is larger than the preset value and
turn off the Night Mode of the browser if the browser of the terminal device is in the Night Mode.

11. A non-transitory computer-readable medium storing instructions which, when being executed by one or more processors, cause a device to perform a method for controlling an application, comprising:
obtaining a light intensity value of an environment, at which a terminal device is located;
determining whether the light intensity value of the environment is less than or equals to a preset value;
determining whether a browser of the terminal device is in a Night Mode if the light intensity value of the environment is less than or equals to the preset value; and
turning on the Night Mode of the browser of the terminal device if the browser is not in the Night Mode.
